(19) United States
(12) Patent Application Publication
(10) Pub. No.: US 2004/0042222 A1
(43) Pub. Date: Mar. 4, 2004

(54) Lock-A-Lite mounting bracket

(76) Inventor: Henry Turner Childs, Chattanooga, TN (US)

Correspondence Address: Henry T. Childs, P.O. Box 9128, Chattanooga, TN, 37412, US

(21) Appl. No.: 10/233,389

(22) Filed: Sep. 3, 2002

(51) Int. Cl. F21S 8/00; F21S 13/02

(52) U.S. Cl. 362/432; 362/147

(57) ABSTRACT

This invention is an improved method and apparatus for coupling an electrical hanging light fixture to its respective electrical open base ceiling box, anchored at ceiling height, to receive and support the hanging fixture. With the lintel type mounting bracket securely connected across the open base ceiling box, the installer can then, with one motion, raise the fully assembled light fixture to the ceiling box and hook its nipple's upper end and nut into the mounting bracket's center side slot, thus easily hanging the assembled light fixture.

### BACKGROUND OF THE INVENTION

There are various designs of light fixtures in use today that are connected to, or positioned to hang from an electrical ceiling box. Some are positioned flush with the ceiling, such as a bedroom ceiling fixture, while others are positioned to hang from the ceiling box by means of support, such as chains, ropes, or even the fixture's own electrical cord.

At present, the assembly and installation of hanging a light fixture to its respective ceiling box presents the installer with a cumbersome and unwieldy job. He assembles his assigned fixture, then positions himself in an elevated position and holds the fixture against the ceiling box, while coupling the light fixture to the ceiling box's mounting strip.

Another method of hanging a light fixture is for the installer to install the fixture's nipple, with its chain holder attached, into the ceiling box's mounting strap, then after assembling the fixture's canopy, chain, collar, and wiring parts, raise the assembly to the ceiling box and, while standing in an elevated position, hold the assembly in place, while connecting the chain to the nipple's chain holder and threading the wires up through the nipple into the ceiling box. Either present method of installation offers a cumbersome and unwieldy method of installation.

This invention offers an improved method and apparatus for the electrical installer to couple his assembled light fixture to its respective ceiling box. After assembling the light fixture and attaching the lintel type Lock-A-Lite mounting bracket to the ceiling box, the installer can, with one hanging motion, hook the assembled fixture's nipple and nut to its respective ceiling box's Lock-A-Lite mounting bracket, thus eliminating a cumbersome job.

This invention relates to a method and apparatus for improving the coupling of an electrical light fixture to its respective ceiling box.

### SUMMARY OF THE INVENTION

The purpose of this invention is to provide an improved, inexpensive method and apparatus for coupling an electrical light fixture to its respective electrical ceiling box.

Various other features of the method and apparatus of the present invention will become obvious to those skilled in the art upon reading the disclosure set forth hereinafter.

### BRIEF DESCRIPTION OF DRAWINGS

FIG. 1 is a view of the apparatus, Lock-A-Lite, showing its features and design, to be used as a lintel to span the open base electrical ceiling box.

FIG. 2 shows the Lock-A-Lite mounting bracket connected in its lintel position across the open base of the ceiling box with the proposed hanging light fixture positioned below, representing a typical mounting assembly prior to mounting.

FIG. 3 illustrates a cut-a-way view of the ceiling box and its Lock-A-Lite mounting bracket showing a typical mounting assembly of the light fixture after mounting.

FIG. 4 shows an enlarged view of the light fixture's mounting assembly in relation to the Lock-A-Lite mounting bracket.

Corresponding reference characters indicate corresponding parts throughout the view of the drawings.

### DETAILED DESCRIPTION

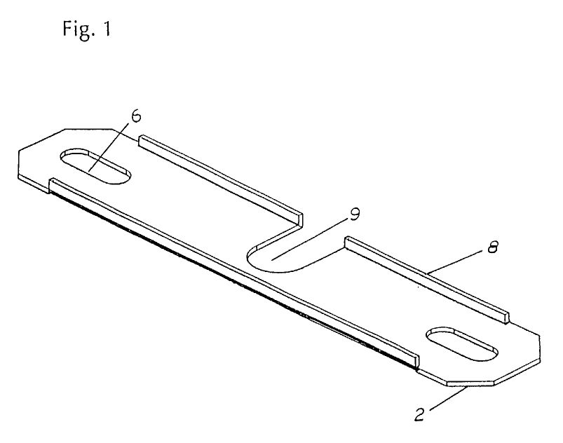

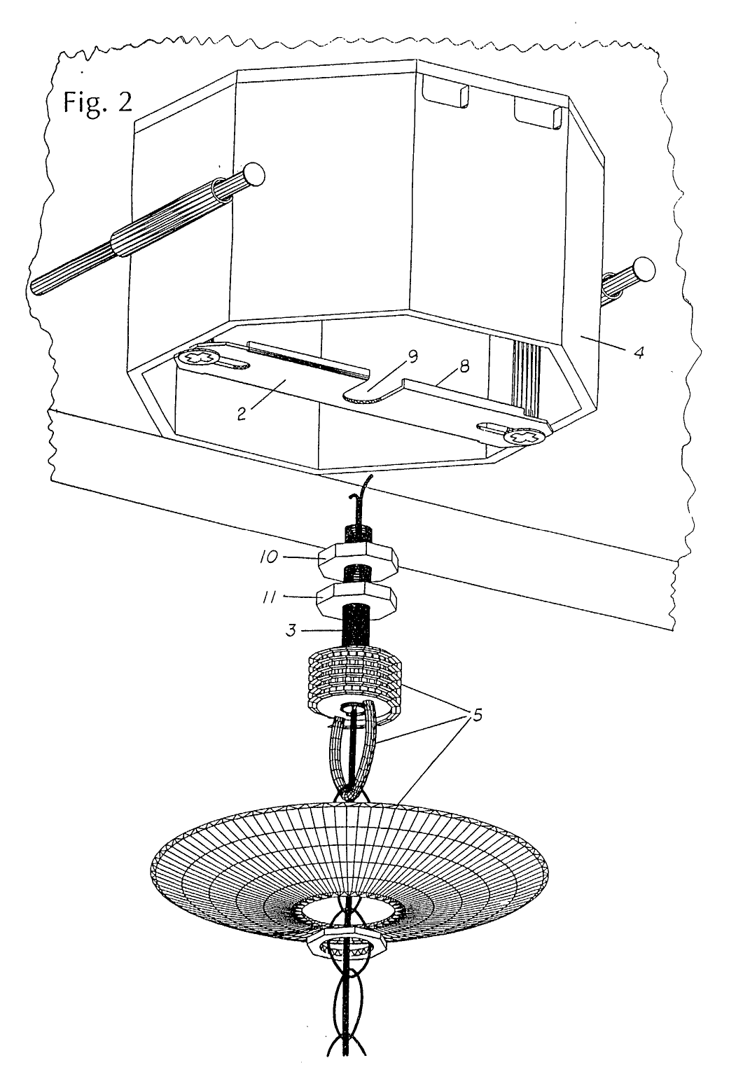

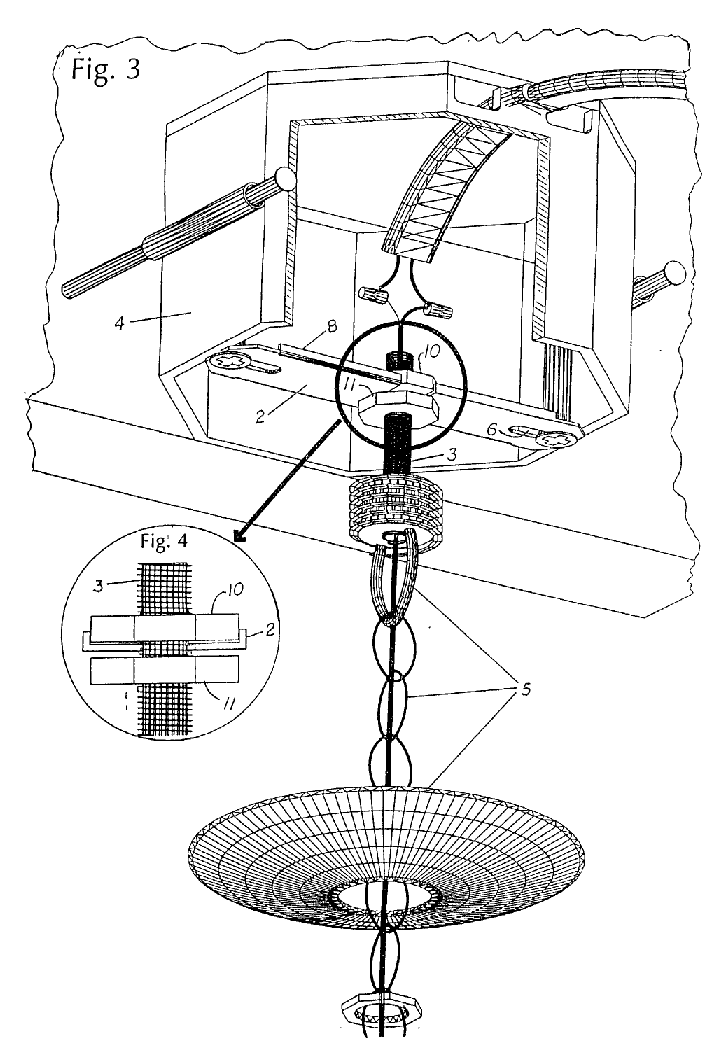

There is illustrated in FIG. 1 of the four drawing figures, the quick coupling Lock-A-Lite mounting bracket 2, with lintel features, and that has parallel sides and is the length suitable to span the diameter of an electrical open base ceiling box 4 (see FIGS. 2 & 3), and the width and thickness to support the weight of a specific electrical hanging light fixture 5 (see FIGS. 2 & 3). Positioned in each end of the bracket is a slot 6 that will align with the specific holes in the lower sides of the ceiling box 4, and having means for fastening each end of the bracket to the ceiling box 4. Positioning down opposite lineal sides is matching perpendicular coinciding flanges 8, extending parallels the approximate length of the bracket 2, for rigidity. Located near the center of one side of bracket 2 is a slot 9, containing a 180° degree arc, extending into the width of the bracket 2 sufficiently to accommodate the light fixture's outer threaded nipple 3 (see FIGS. 2 & 3) and its upper positioned nut 10 (see FIGS. 2, 3, & 4). The lower nut 11, positioned on the nipple 3 below the upper nut 10 is adjusted to allow space for quick coupling the light fixture's nipple 3 and upper nut 10 to the Lock-A-Lite mounting bracket 2. After hanging the light fixture, 5 the lower positioned nut 11 on the nipple 3 can then be raised until its desired adjustment is reached, with the bottom of the bracket 2.

The electrician's preparation for hanging an electrical light fixture to its respective ceiling box, consists of the positioning the Lock-A-Lite mounting bracket, with its perpendicular flanges in an up position, and the bracket's end slots, with attaching means, attached to the corresponding means of attachment on the open base ceiling box. This positions the Lock-A-Lite bracket for receiving its corresponding hanging light fixture, when assembled. After assembly, the installer raises the fixture by its nipple, adjusts the nipple's two nuts apart, and with one motion, hangs the fixture to the Lack-A-Lite bracket. Any adjustment of the nipple nuts 10 and 11 against the Lock-A-Lite bracket completes the cumbersome job made simple.

Any appropriate wiring in the ceiling box is ready for completion.

It is to be understood that the foregoing drawings and description of the invention is to be taken as a preferred embodiment and that various other modifications will occur to those skilled in the art upon reading the disclosure, however, all changes and modifications that come within the spirit of the invention are desired to be protected.

1. A method of hanging an electrical light fixture to its respective electrical ceiling box, comprising the steps of
a. having an electrical ceiling box positioned to receive an assembled hanging type light fixture,
b. having an electrical light fixture fully assembled to its outer threaded nipple containing two adjustable nuts for hanging to its respective ceiling box,
c. having a supporting mounting bracket, with parallel sides and being of sufficient length to span the diameter of the open base ceiling box, and sufficient in width and thickness to support the weight of the respective hanging light fixture,
d. installing in each end of the bracket matching slots that are aligned with the specific holes in the lower sides of the open base ceiling box, having means of attachment,
e. positioning down opposite lineal sides of the bracket matching perpendicular coinciding flanges extending parallel the approximate length of the mounting bracket for rigidity,
f. installing a slot near the center, on one side of the mounting bracket, containing a 180° degree arc, being sufficient in size to accept the light fixture's nipple and its upper positioned nut,
g. connecting the means of attachment of the two supporting mounting bracket ends with the respective attaching means of the ceiling box,
h. positioning apart the two nuts on the light fixture's nipple thus allowing space for hanging the nipple and its top nut on the center side slot of the supporting mounting bracket,
i. hanging the assembled light fixture to the supporting mounting bracket's center slot by hooking the fixture's upper nipple nut into and over the center slot, and adjusting the nipple's lower nut up against the bottom of the supporting mounting bracket, thus hanging the light fixture to its respective ceiling box.

2. An apparatus for hanging an electrical light fixture to its respective electrical ceiling box, comprising:
a. an electrical ceiling box positioned to receive an assembled hanging type light fixture,
b. an electrical light fixture fully assembled to its outer threaded nipple containing two adjustable nuts for hanging to its respective ceiling box,
c. a lintel type mounting bracket, with parallel sides and being of sufficient length to span the diameter of the open base ceiling box, and sufficient in width and thickness to support the weight of the respective hanging light fixture,
d. the mounting bracket having matching slots in each end that are aligned with the specific holes in the lower sides of the open base ceiling box and containing means of attachment.
e. the mounting bracket having down opposite lineal sides matching perpendicular coinciding flanges extending parallel the approximate length of the bracket, for rigidity,
f. the mounting bracket with a slot containing a 180° degree arc, located near the center of one side of the bracket and being sufficient in size to accept the light fixture's nipple and its upper positioned nut,
g. the mounting bracket with its means of attachment of its two supporting bracket ends connected with the respective attaching means of the ceiling box,
h. the two nuts on the light fixture's nipple positioned apart, thus granting space for hanging the nipple and its top nut on the center side slot of the supporting mounting bracket,
i. the assembled light fixture hung to the supporting bracket's center slot by hooking the fixture's upper nipple nut into and over the center slot, and adjusting the nipple's lower nut up against the bottom of the supporting bracket, thus hanging the fixture to its respective ceiling box.
